(19) United States
(12) Patent Application Publication
(10) Pub. No.: US 2021/0250755 A1
(43) Pub. Date: Aug. 12, 2021

(54) APPARATUS AND METHOD FOR DELETION OF USER EQUIPMENT CAPABILITY IDENTITY

(71) Applicant: GUANGDONG OPPO MOBILE TELECOMMUNICATIONS CORP., LTD., Dongguan (CN)

(72) Inventor: JIANHUA LIU, Dongguan (CN)

(21) Appl. No.: 17/240,221

(22) Filed: Apr. 26, 2021

Related U.S. Application Data
(63) Continuation of application No. PCT/CN2019/080507, filed on Mar. 29, 2019.

(51) Int. Cl. H04W 8/24; H04W 76/25

(52) U.S. Cl. CPC H04W 8/24; H04W 84/042; H04W 76/25

(57) ABSTRACT

An apparatus and a method for deletion of UE (user equipment) capability identity (ID) capable of providing a good communication performance and high reliability are provided. A method for deletion of UE capability ID of a UE includes indicating whether a type of a UE capability ID to be used and performing the indication.

### CROSS-REFERENCE TO RELATED APPLICATION

The present application is a continuation application of International PCT Application No. PCT/CN2019/080507, filed on Mar. 29, 2019, the entire content of which is hereby incorporated by reference.

### BACKGROUND OF DISCLOSURE

### 1. Field of Disclosure

The present disclosure relates to the field of communication systems, and more particularly, to an apparatus and a method for deletion of UE (user equipment) capability identity (ID).

### 2. Description of Related Art

Universal terrestrial radio access network (UTRAN) is a radio access network of a universal mobile telecommunications system (UMTS), wherein the UTRAN consists of radio network controllers (RNCs) and Node Bs (i.e. radio base stations). The Node Bs communicate wirelessly with mobile terminals and the RNCs control the Node Bs. The RNCs are further connected to the core network (CN). Evolved UTRAN (E-UTRAN) is the evolution of the UTRAN towards a high-data rate, low-latency, and packet-optimized radio access network. Further, E-UTRAN consists of interconnected eNodeBs (evolved Node Bs) that are further connected to the evolved packet core network (EPC). E-UTRAN is also being referred to as long term evolution (LTE) and standardized within the 3rd Generation Partnership Project (3GPP).

To allow for a wide range of user equipment (UE) implementations, different UE capabilities are specified. The UE capabilities are divided into a number of parameters, which are sent from the UE at the establishment of a connection and if/when the UE capabilities are changed during an ongoing connection. The UE capabilities may then be used by the network to select a configuration that is supported by the UE.

In an existing system, capabilities of a terminal are reported to the access network when registering or registering the update, and then the access network sends the capabilities of the terminal to the core network for storage. When the terminal initiates a connection establishment request, the access network requests the core network for capability information of the terminal, and then provides the terminal with the configuration according to the capability information of the terminal.

As the terminal supports more and more features, the capability information of the terminal will become larger and larger, which will bring huge signaling overhead. In addition, the core network needs to save the capability information of all terminal registrations, and also brings the core network bigger challenge.

Therefore, there is a need for an apparatus and a method for deletion of UE (user equipment) capability identity (ID).

### SUMMARY

An object of the present disclosure is to propose an apparatus and a method for deletion of UE (user equipment) capability identity (ID) capable of providing a good communication performance and high reliability.

In a first aspect of the present disclosure, a user equipment (UE) for deletion of UE (user equipment) capability identity (ID) includes a memory, a transceiver, and a processor coupled to the memory and the transceiver. The processor is configured to control the transceiver to receive an indication from a network node, wherein the indication includes indicating whether a type of a UE capability ID to be used, and the processor is configured to perform the indication.

In a second aspect of the present disclosure, a method for deletion of UE (user equipment) capability identity (ID) of a user equipment includes receiving an indication from a network node, wherein the indication includes indicating whether a type of a UE capability ID to be used, and performing the indication.

In a third aspect of the present disclosure, a network node for deletion of UE (user equipment) capability identity (ID) includes a memory, a transceiver, and a processor coupled to the memory and the transceiver. The processor is configured to control the transceiver to send, to a UE, an indication, wherein the indication includes indicating whether a type of a UE capability ID to be used.

In a fourth aspect of the present disclosure, a method for deletion of UE (user equipment) capability identity (ID) of a network node includes sending, to a UE, an indication, wherein the indication includes indicating whether a type of a UE capability ID to be used.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the implementations of the present disclosure or related art, the following figures will be described in the implementations are briefly introduced. It is obvious that the drawings are merely some implementations of the present disclosure, a person having ordinary skill in this field can obtain other figures according to these figures without paying the premise.

FIG. 1 is a block diagram of a user equipment and a network node for deletion of UE (user equipment) capability identity (ID) according to an implementation of the present disclosure.

FIG. 2 is a flowchart illustrating a method for deletion of UE (user equipment) capability identity (ID) of a user equipment according to an implementation of the present disclosure.

FIG. 3 is a flowchart illustrating a method for deletion of UE (user equipment) capability identity (ID) of a network node according to an implementation of the present disclosure.

FIG. 4 is a schematic diagram of an exemplary illustration of a deletion execution procedure of a UE (user equipment) capability identity (ID) according to an implementation of the present disclosure.

FIG. 5 is a block diagram of a system for wireless communication according to an implementation of the present disclosure.

### DETAILED DESCRIPTION OF IMPLEMENTATIONS

Implementations of the present disclosure are described in detail with the technical matters, structural features, achieved objects, and effects with reference to the accompanying drawings as follows. Specifically, the terminologies in the implementations of the present disclosure are merely for describing the purpose of the certain implementation, but not to limit the disclosure.

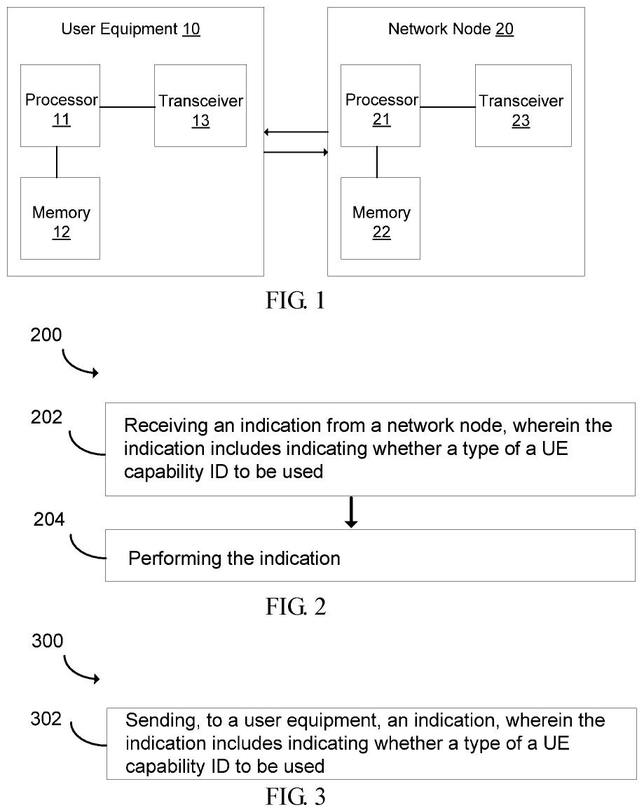

FIG. 1 illustrates that, in some implementations, a user equipment (UE) 10 and a network node 20 for deletion of UE (user equipment) capability identity (ID) according to an implementation of the present disclosure are provided. The UE 10 may include a processor 11, a memory 12, and a transceiver 13. The network node 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the implementations are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, and beyond. UEs communicate with each other directly via a sidelink interface such as a PC5 interface.

A solution of an implementation of the present disclosure is to propose an apparatus and a method for deletion of UE (user equipment) capability identity (ID) capable of providing a good communication performance and high reliability.

UE capabilities can be classified into mainly two sets of capability categories depending on which layer of the protocol hierarchy the given capability information is related to:

Access stratum (AS) capabilities: these are the access technology dependent parts of the capability information such as terminal power class, supported frequency band etc. The AS capabilities are needed by the eNodeB.

Non access stratum (NAS) capabilities: this set of capability information holds the non access specific parts of the UE capability such as supported security algorithms. The NAS capabilities are used by an evolved packet core network (EPC).

In some implementations, the processor 11 is configured to control the transceiver 13 to receive an indication from a network node 20, wherein the indication includes indicating whether a type of a UE capability ID to be used, and the processor 11 is configured to perform the indication.

In some implementations, the indication includes type information of the UE capability ID including a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID. In some implementations, the indication is provided via a radio resource control (RRC) signaling or a non-access stratum (NAS) signaling. In some implementations, the processor 11 is configured to control the transceiver 13 to receive a NAS message from a core network (CN) entity of the network node 20, and the NAS message includes a UE configuration update (UCU) associated with the UE capability ID invalid or deletion.

In some implementations, the UCU includes using 1 bit to indicate all UE capability IDs UE stored for a PLMN invalid or deletion. In some implementations, the UCU includes indicating which UE capability ID UE stored invalid or deletion. In some implementations, the UCU includes indicating the UE capability ID in a specific area invalid or deletion, and the specific area is a specific registration area, a tracking area (TA) list, or a geographical area.

In some implementations, the processor 11 is configured to initiates an initial NAS message including the UE capability ID. In some implementations, the initial NAS message includes a registration request message or a service request message. In some implementations, the processor 11 is configured to control the transceiver 13 to receive a response message in response to the initial NAS message from the CN entity, and the response message includes the UE capability ID invalid or deletion.

In some implementations, the processor 21 is configured to control the transceiver 23 to send, to the UE 10, an indication, wherein the indication includes indicating whether a type of a UE capability ID to be used.

In some implementations, the indication includes type information of the UE capability ID including a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID. In some implementations, the indication is provided via a radio resource control (RRC) signaling or a non-access stratum (NAS) signaling. In some implementations, the network node 20 includes a UE capability management function (UCMF) entity and a core network (CN) entity, the CN entity and the UCMF entity have direct or indirect connection. In some implementations, the UCMF entity is configured to detect the UE capability ID invalid or cleared and send a notification message to inform the CN entity a situation associated with the UE capability ID invalid or cleared. In some implementations, the invalid or cleared UE capability ID is an ID for a specific UE, a, some, or all UEs belonging to a specific PLMN, or a, some, or all UEs belonging to a specific UE manufacturer, or the invalid or cleared UE capability ID has one or some IDs if the UE has multiple IDs.

In some implementations, if the CN entity has stored the invalid or cleared UE capability ID, the CN entity deletes the invalid or cleared UE capability ID and information associated with the invalid or cleared UE capability ID. In some implementations, if the CN entity has no valid ID for a specific UE or a set of capabilities, and the CN entity fails to retrieve the invalid or cleared UE capability ID and/or capabilities thereof from the UCMF entity. In some implementations, the CN entity is configured to inform, to the UE, a NAS message, and the NAS message includes a UE configuration update (UCU) associated with the UE capability ID invalid or deletion.

In some implementations, the UCU includes using 1 bit to indicate all UE capability IDs UE stored for a PLMN invalid or deletion. In some implementations, the UCU includes indicating which UE capability ID UE stored invalid or deletion. In some implementations, the UCU includes indicating the UE capability ID in a specific area invalid or deletion, and the specific area is a specific registration area, a tracking area (TA) list, or a geographical area.

In some implementations, the processor 11 is configured to receive an initial NAS message including the UE capability ID from the UE 10. In some implementations, the initial NAS message includes a registration request message or a service request message. In some implementations, the CN entity cannot understand the UE capability ID, has no capabilities information related to the UE capability ID, or cannot retrieve the UE capability ID and/or capabilities information related to the UE capability ID from the UCMF entity.

In some implementations, the CN entity is configured to inform, to the UE 10, a response message in response to the initial NAS message, and the response message includes the UE capability ID invalid or deletion. In some implementations, the CN entity is configured to notify, to a radio access network (RAN) entity of the network node, neither UE capability ID nor capabilities related to UE capability ID available or an indication for deleting the UE capability ID if the RAN entity stores; or the CN entity is configured to send, to the RAN entity, a message without the UE capability ID and/or capabilities related to UE capability ID. In some implementations, the RAN entity is configured to retrieve the UE capability ID from the UE 10 using an RRC message or a NAS message.

In some implementations, after the RAN entity retrieves the UE capability ID from the UE using the RRC message or the NAS message, the UE deletes the UE capability ID, or if there is no UE capability ID, UE 10 deletes all IDs associated with a PLMN. In some implementations, the RAN entity is configured to receive UE capability information from the UE, wherein the UE capability information includes the UE capability ID and/or other type UE capability ID different from the UE capability ID.

In some implementations, the RAN entity is configured to notify, to the CN entity, the UE capability information. In some implementations, the CN entity is configured to store the UE capability information. In some implementations, the CN entity is configured to notify, to the UCMF entity, the UE capability information.

FIG. 2 illustrates a method 200 for deletion of UE (user equipment) capability identity (ID) of a UE according to an implementation of the present disclosure. The method 200 includes: a block 202, receiving an indication from a network node, wherein the indication includes indicating whether a type of a UE capability ID to be used, and a block 204, performing the indication.

In some implementations, the indication includes type information of the UE capability ID including a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID. In some implementations, the indication is provided via a radio resource control (RRC) signaling or a non-access stratum (NAS) signaling.

In some implementations, the method further includes receiving a NAS message from a core network (CN) entity of the network node, and the NAS message includes a UE configuration update (UCU) associated with the UE capability ID invalid or deletion. In some implementations, the UCU includes using 1 bit to indicate all UE capability IDs UE stored for a PLMN invalid or deletion. In some implementations, the UCU includes indicating which UE capability ID UE stored invalid or deletion. In some implementations, the UCU includes indicating the UE capability ID in a specific area invalid or deletion, and the specific area is a specific registration area, a tracking area (TA) list, or a geographical area. In some implementations, the method further includes initiating an initial NAS message including the UE capability ID.

In some implementations, the initial NAS message includes a registration request message or a service request message. In some implementations, the method further includes receiving a response message in response to the initial NAS message from the CN entity, and the response message includes the UE capability ID invalid or deletion.

FIG. 3 illustrates a method 300 for deletion of UE (user equipment) capability identity (ID) of a network node according to an implementation of the present disclosure. The method 300 includes: a block 302, sending, to a UE, an indication, wherein the indication includes indicating whether a type of a UE capability ID to be used.

In some implementations, the indication includes type information of the UE capability ID including a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID. In some implementations, the indication is provided via a radio resource control (RRC) signaling or a non-access stratum (NAS) signaling. In some implementations, the network node includes a UE capability management function (UCMF) entity and a core network (CN) entity, the CN entity and the UCMF entity have direct or indirect connection.

In some implementations, the UCMF entity is configured to detect the UE capability ID invalid or cleared and send a notification message to inform the CN entity a situation associated with the UE capability ID invalid or cleared. In some implementations, the invalid or cleared UE capability ID is an ID for a specific UE, a, some, or all UEs belonging to a specific PLMN, or a, some, or all UEs belonging to a specific UE manufacturer, or the invalid or cleared UE capability ID has one or some IDs if the UE has multiple IDs. In some implementations, if the CN entity has stored the invalid or cleared UE capability ID, the CN entity deletes the invalid or cleared UE capability ID and information associated with the invalid or cleared UE capability ID. In some implementations, if the CN entity has no valid ID for a specific UE or a set of capabilities, and the CN entity fails to retrieve the invalid or cleared UE capability ID and/or capabilities thereof from the UCMF entity.

In some implementations, the CN entity is configured to inform, to the UE, a NAS message, and the NAS message includes a UE configuration update (UCU) associated with the UE capability ID invalid or deletion. In some implementations, the UCU includes using 1 bit to indicate all UE capability IDs UE stored for a PLMN invalid or deletion. In some implementations, the UCU includes indicating which UE capability ID UE stored invalid or deletion. In some implementations, the UCU includes indicating the UE capability ID in a specific area invalid or deletion, and the specific area is a specific registration area, a tracking area (TA) list, or a geographical area.

In some implementations, the method further includes receiving an initial NAS message including the UE capability ID from the UE. In some implementations, the initial NAS message includes a registration request message or a service request message. In some implementations, the CN entity cannot understand the UE capability ID, has no capabilities information related to the UE capability ID, or cannot retrieve the UE capability ID and/or capabilities information related to the UE capability ID from the UCMF entity. In some implementations, the CN entity is configured to inform, to the UE, a response message in response to the initial NAS message, and the response message includes the UE capability ID invalid or deletion.

In some implementations, the CN entity is configured to notify, to a radio access network (RAN) entity of the network node, neither UE capability ID nor capabilities related to UE capability ID available or an indication for deleting the UE capability ID if the RAN entity stores; or the CN entity is configured to send, to the RAN entity, a message without the UE capability ID and/or capabilities related to UE capability ID. In some implementations, the RAN entity is configured to retrieve the UE capability ID from the UE using an RRC message or a NAS message. In some implementations, after the RAN entity retrieves the UE capability ID from the UE using the RRC message or the NAS message, the UE deletes the UE capability ID, or if there is no UE capability ID, UE deletes all IDs associated with a PLMN.

In some implementations, the RAN entity is configured to receive UE capability information from the UE, wherein the UE capability information includes the UE capability ID and/or other type UE capability ID different from the UE capability ID. In some implementations, the RAN entity is configured to notify, to the CN entity, the UE capability information. In some implementations, the CN entity is configured to store the UE capability information. In some implementations, the CN entity is configured to notify, to the UCMF entity, the UE capability information.

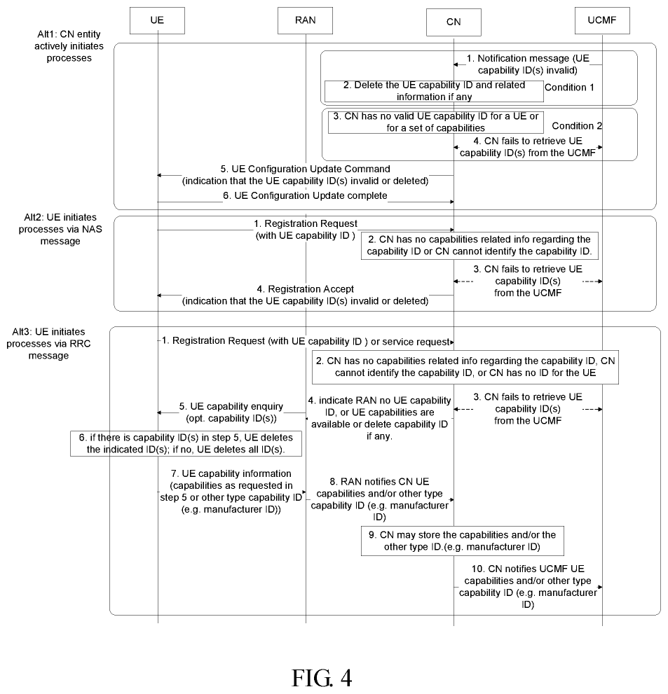

FIG. 4 illustrates an exemplary illustration of a deletion execution procedure of a UE (user equipment) capability identity (ID) according to an implementation of the present disclosure.

An implementation of the present disclosure proposes to indicate a terminal to delete the allocated capability identification information through a NAS signaling or RRC signaling. The NAS signaling includes a registration process and a terminal configuration update process. The RRC signaling includes a terminal capability acquisition reconfiguration process.

In some implementations, an improved method is to match a specific terminal capability information to a capability ID, and only the capability ID information of the terminal is saved when the terminal reports and a network saves the terminal capability. In a specific case, the network deletes the capability ID information of the terminal locally, for example, the network is locally implemented or the network is faulty. In this case, the network needs to notify the terminal to delete the assigned capability ID.

In some implementations, the network may indicate to the UE whether type of ID will be used. The detailed indication could be: 1) the type information, e.g. PLMN-specific capability ID or manufacturer specific capability ID, 2) delete the PLMN specific capability ID, 3) delete the manufacturer capability ID, 4) ignore the PLMN specific capability ID, and/or reuse the PLMN-specific ID. The indication can be provided to the UE via RRC signaling, or NAS signaling.

In some implementations, detailed procedure is as following. Steps for three alternatives are following.

Alternative 1 (Alt1): Network-initiated. CN entity actively initiates processes.

Condition 1: Step 1: UCMF entity detects UE capability ID(s) invalid or cleared, UCMF sends notification message to inform CN the situation. The invalid or cleared capability ID can be an ID for specific UE or a/some/all UE(s) belonging to a specific PLMN or a/some/all UE(s) belonging to a specific UE manufacturer. Or the capability ID can be one or some ID(s) if UE has multiple ID(s). Step 2: if the CN has the stored capability ID(s), the CN entity delete the ID(s) and related information.

Or Condition 2: Steps 3-4: If the CN entity has no valid ID(s) for a specific UE or a set of capabilities, and the CN entity fails to retrieve the capability ID(s) and/or capabilities from the UCMF.

Steps 5-6: The CN entity informs the UE via NAS message, e.g. UE configuration update, the capability ID(s) invalid or deletion. In details, Option 1: using 1 bit to indicate all the capability ID(s) UE stored for the PLMN invalid or deletion. Option 2: indicate which capability ID(s) UE stored invalid or deletion. Option 3: indicate the ID(s) in specific area invalid or deletion, e.g. specific Registrations Area, TA list, geographical area.

Alternative 2 (Alt2): UE-initiated-NAS. UE initiates processes via NAS message.

Step 1. UE initiates initial NAS message, including capability ID, e.g. Registration Request message; or UE initiates Service Request message.

Step 2. The CN entity cannot understand the capability ID or has no capabilities information related to the capability ID, or Step 3. The CN entity cannot retrieve capability ID and/or related capabilities information from the UCMF.

Step 4. The CN entity informs the UE in the response message to the initial NAS message, the capability ID(s) invalid or deletion. Detailed information is same as Alt1.

Alternative (Alt3): UE-initiated-RRC. UE initiates processes via RRC message.

Step 1. UE initiates initial NAS message, including capability ID, e.g. Registration Request message, Service Request message.

Step 2. The CN entity cannot understand the capability ID or has no capabilities information related to the capability ID, or Step 3. The CN entity cannot retrieve capability ID and/or related capabilities information from the UCMF.

Step 4. The CN entity notifies RAN neither capability ID nor capabilities available or indication for deleting capability ID if RAN stores, or the CN entity sends RAN message without capability ID and/or the CN entity sends RAN message without capabilities.

Step 5. The RAN node retrieves UE capabilities from the UE using RRC message. Optionally, can include capability ID related information as Alt1 step 5.

Step 6. UE deletes the ID(s) associated with information in step 5. If there is no capability ID related information in step 5, UE deletes all ID(s) associated with the PLMN.

Step 7. The RAN entity is configured to receive UE capability information from the UE, wherein the UE capability information includes the UE capability ID and/or other type UE capability ID different from the UE capability ID. That is, the UE capability information has capabilities as requested in step 5 or other type capability ID (e.g. manufacturer ID)

Step 8. The RAN entity is configured to notify, to the CN entity, the UE capability information. Step 9. The CN entity is configured to store the UE capability information. Step 10. The CN entity is configured to notify, to the UCMF entity, the UE capability information.

In the above implementations, the CN entity can refer to an access and mobility management function (AMF). The capability ID refers to PLMN assigned capability ID or manufacturer assigned ID. The CN entity and UCMF can have direct or indirect connection.

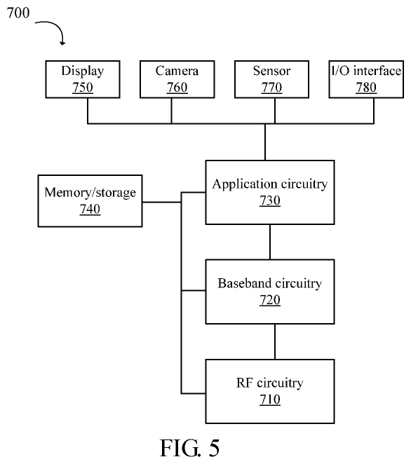

FIG. 5 is a block diagram of an example system 700 for wireless communication according to an implementation of the present disclosure. Implementations described herein may be implemented into the system using any suitably configured hardware and/or software. FIG. 5 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some implementations, the baseband circuitry may provide for communication compatible with one or more radio technologies. For example, in some implementations, the baseband circuitry may support communication with an evolved universal terrestrial radio access network (EUTRAN) and/or other wireless metropolitan area networks (WMAN), a wireless local area network (WLAN), a wireless personal area network (WPAN). Implementations in which the baseband circuitry is configured to support radio communications of more than one wireless protocol may be referred to as multi-mode baseband circuitry.

In various implementations, the baseband circuitry 720 may include circuitry to operate with signals that are not strictly considered as being in a baseband frequency. For example, in some implementations, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various implementations, the RF circuitry may include switches, filters, amplifiers, etc. to facilitate the communication with the wireless network.

In various implementations, the RF circuitry 710 may include circuitry to operate with signals that are not strictly considered as being in a radio frequency. For example, in some implementations, RF circuitry may include circuitry to operate with signals having an intermediate frequency, which is between a baseband frequency and a radio frequency.

In various implementations, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some implementations, the electronic device circuitry may be implemented in, or functions associated with the circuitry may be implemented by, one or more software or firmware modules.

In some implementations, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one implementation may include any combination of suitable volatile memory, such as dynamic random access memory (DRAM)), and/or non-volatile memory, such as flash memory.

In various implementations, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various implementations, the sensor 770 may include one or more sensing devices to determine environmental conditions and/or location information related to the system. In some implementations, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various implementations, the display 750 may include a display, such as a liquid crystal display and a touch screen display. In various implementations, the system 700 may be a mobile computing device such as, but not limited to, a laptop computing device, a tablet computing device, a netbook, an ultrabook, a smartphone, etc. In various implementations, system may have more or less components, and/or different architectures. Where appropriate, methods described herein may be implemented as a computer program. The computer program may be stored on a storage medium, such as a non-transitory storage medium.

In the implementation of the present disclosure, an apparatus and a method for deletion of UE (user equipment) capability identity (ID) capable of providing a good communication performance and high reliability. The implementation of the present disclosure is a combination of techniques/processes that can be adopted in 3GPP specification to create an end product.

A person having ordinary skill in the art understands that each of the units, algorithm, and steps described and disclosed in the implementations of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned implementation since the working processes of the above-mentioned system, device, and unit are basically the same. For easy description and simplicity, these working processes will not be detailed.

It is understood that the disclosed system, device, and method in the implementations of the present disclosure can be realized with other ways. The above-mentioned implementations are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the implementations. Moreover, each of the functional units in each of the implementations can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the implementations of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred implementations, it is understood that the present disclosure is not limited to the disclosed implementations but is intended to cover various arrangements made without departing from the scope of the broadest interpretation of the appended claims.

What is claimed is:

1. A user equipment (UE) for deletion of UE capability identity (ID), comprising:
a memory;
a transceiver; and
a processor coupled to the memory and the transceiver,
wherein the processor is configured to:
control the transceiver to receive an indication from a network node, wherein the indication comprises indicating whether a type of a UE capability ID to be used; and
perform the indication.

2. The UE of claim 1, wherein the indication comprises type information of the UE capability ID comprising a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID.

3. The UE of claim 1, wherein the indication is provided via a radio resource control (RRC) signaling or a non-access stratum (NAS) signaling.

4. A method for deletion of UE (user equipment) capability identity (ID) of a UE, comprising:
receiving an indication from a network node, wherein the indication comprises indicating whether a type of a UE capability ID to be used; and
performing the indication.

5. The method of claim 4, wherein the indication comprises type information of the UE capability ID comprising a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID.

6. The method of claim 4, wherein the indication is provided via a radio resource control (RRC) signaling or a non-access stratum (NAS) signaling.

7. A network node for deletion of UE (user equipment) capability identity (ID), comprising:
a memory;
a transceiver; and
a processor coupled to the memory and the transceiver,
wherein the processor is configured to:
control the transceiver to send, to a UE, an indication, wherein the indication comprises indicating whether a type of a UE capability ID to be used.

8. The network node of claim 7, wherein the indication comprises type information of the UE capability ID comprising a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID.

9. The network node of claim 7, wherein the indication is provided via a radio resource control (RRC) signaling or a non-access stratum (NAS) signaling.

10. A method for deletion of UE (user equipment) capability identity (ID) of a network node, comprising:
sending, to a UE, an indication, wherein the indication comprises indicating whether a type of a UE capability ID to be used.

11. The method of claim 10, wherein the indication comprises type information of the UE capability ID comprising a public land mobile network (PLMN) specific UE capability ID or a manufacturer specific UE capability ID, deleting the PLMN specific UE capability ID, deleting the manufacturer specific UE capability ID, ignoring the PLMN specific UE capability ID, and/or reusing the PLMN specific UE capability ID.

12. The method of claim 10, wherein the indication is provided via a radio resource control (RRC) signaling or a non-access stratum (NAS) signaling.
